(19) United States
(12) Patent Application Publication
(10) Pub. No.: US 2026/0295750 A1
(43) Pub. Date: Oct. 1, 2026

(54) CHIP CONVEYOR

(71) Applicant: DMG MORI CO., LTD., NARA (JP)

(72) Inventors: Yuhei KITADE, NARA (JP); Kosuke YAMAMOTO, NARA (JP)

(73) Assignee: DMG MORI CO., LTD., NARA (JP)

(21) Appl. No.: 19/163,316

(22) PCT Filed: Mar. 10, 2023
(86) PCT No.: PCT/JP2023/009317

§ 371 Date: Sep. 8, 2025

(51) Int. Cl. B23Q 11/00; B65G 25/08

(52) U.S. Cl. CPC B23Q 11/0042; B65G 25/08

(57) ABSTRACT

A chip conveyor (1) includes a housing (10) that has an inlet (11a) receiving chips and a discharge outlet (13f) discharging the chips downward, and a conveying mechanism (20) that is housed in the housing (10) and configured to convey the chips received through the inlet (11a) toward the discharge outlet (13f). The chip conveyor is configured to discharge the chips to a chip bucket (100) disposed below the discharge outlet (13f). A tubular body (132) open at top and bottom thereof is engaged with a discharge portion (13) of the housing (10) where the discharge outlet (13f) is formed, so that an internal space of the tubular body communicates with the discharge outlet (13f). The tubular body (132) is provided such that a height position of its lower end opening (132e) is displaceable.

### TECHNICAL FIELD

The present invention relates to a chip conveyor.

### BACKGROUND ART

Traditionally, a chip conveyor configured to discharge chips generated in a machining area of a machine tool to the outside of the machine tool has been known (e.g., see Patent Document 1). The chip conveyor includes a housing that has an inlet to receive chips and a discharge outlet to discharge chips downward, and a conveying mechanism that is housed in the housing and conveys chips received from the inlet toward the discharge outlet. A chip bucket is disposed below the discharge outlet of the chip conveyor to collect chips discharged from the discharge outlet. The chip bucket is open at the top to allow collection of chips that fall freely from the discharge outlet.

### PRIOR ART DOCUMENTS

### Patent Documents

[Patent Document 1] Japanese Unexamined Patent Publication No. 2016-083735

### SUMMARY OF THE INVENTION

### Problem to be Solved

The size of the chip conveyor varies depending on, for example, the size of the machine tool to which it is applied, and therefore, the height position of the discharge outlet also differs depending on the size of the chip conveyor. Further, various sizes of chip buckets are generally used in factories, and the heights of the chip buckets also vary. Thus, when the chip bucket assigned to the chip conveyor is small in size, the upper end position of the chip bucket may be located considerably lower than the discharge outlet of the chip conveyor. In this case, there is a risk that chips discharged from the discharge outlet of the chip conveyor will be scattered around without being collected in the chip bucket, and such scattering of chips may cause contamination around the chip The present invention has been made in view of the above circumstances, and an object thereof is to provide a chip conveyor that can reliably collect chips discharged from the discharge outlet into a chip bucket, without being affected by the height position of the discharge outlet of the chip bucket.

### Solution to Problem

The present invention, which has been made to solve the above-described problem, relates to
a chip conveyor including: a housing that has an inlet receiving chips and a discharge outlet discharging the chips downward; and a conveying mechanism that is housed in the housing and configured to convey the chips received through the inlet toward the discharge outlet, the chip conveyor being configured to discharge the chips through the discharge outlet to a chip bucket disposed below the discharge outlet, wherein:
a tubular body open at top and bottom thereof is engaged with a discharge portion of the housing where the discharge outlet is formed, so that an internal space of the tubular body communicates with the discharge outlet; and
the tubular body is provided such that a height position of its lower end opening is displaceable.

According to the chip conveyor, chips discharged from the discharge outlet of the housing are discharged to the outside through the internal space of the tubular body that communicates with the discharge outlet, and are collected in the chip bucket disposed below the lower end opening of the tubular body. In this chip conveyor, since the tubular body is provided such that the height position of its lower end opening is displaceable, the height position of the lower end opening can be adjusted to a position corresponding to the height of the upper end of the chip bucket. By properly setting the height position of the lower end opening of the tubular body, from which the chips are discharged to the outside, relative to the height of the upper end of the chip bucket, the chips discharged from the lower end opening of the tubular body can be reliably guided into the chip bucket to be collected. As a result, scattering of the chips around the chip bucket can be prevented.

The chip conveyor of the above-described aspect (first aspect) may be configured such that: the discharge portion of the housing is formed in a tubular shape and provided so as to hang downward; the tubular body and the discharge portion are fitted one to the other; and the tubular body is provided to be movable in an up-down direction with respect to the discharge portion. According to this aspect (second aspect), the height position of the lower end opening of the tubular body can be adjusted by moving the tubular body in the up-down direction. It should be noted that the fitting between the tubular body and the discharge portion may be configured such that the tubular body is externally fitted to the discharge portion, or may be configured such that the discharge portion is externally fitted to the tubular body.

Further, the chip conveyor of the second aspect may include a guide mechanism that engages with the discharge portion of the housing and the tubular body and is configured to guide relative up-and-down movement between the discharge portion and the tubular body. According to this aspect (third aspect), the tubular body can be moved smoothly in the up-down direction, so that the height position of the lower end opening of the tubular body can be easily adjusted.

Further, the chip conveyor of the second aspect or the third aspect may include a biasing mechanism that is configured to apply a biasing force against the gravitational force to the tubular body. According to this aspect (fourth aspect), since the biasing mechanism applies a biasing force against the gravitational force to the tubular body, a worker can move the tubular body in the up-down direction with only a small force. In this sense, the height position of the lower end opening of the tubular body can be easily adjusted.

Further, the second aspect, the third aspect, and the fourth aspect may include a positioning mechanism that is configured to position a height position of the tubular body relative to the discharge portion. According to this aspect (fifth aspect), the height position of the tubular body relative to the discharge portion can be positioned by the positioning mechanism, so that the height position of the tubular body can be adjusted in a stable manner with good reproducibility.

The first aspect to the fifth aspect preferably include: a chip detection sensor that is fixed to the tubular body and configured to detect chips accumulated in the chip bucket and to output distance information regarding a distance from the chip detection sensor to the chips; and a notification unit that is configured to determine, based on the distance information output from the chip detection sensor, whether or not the distance from the chip detection sensor to the chips is equal to or smaller than a predetermined distance, and to issue an external notification when the distance is determined to be equal to or smaller than the predetermined distance.

According to this aspect (sixth aspect), the distance information corresponding to the distance between the chip detection sensor fixed to the tubular body and chips in the chip bucket is output from the chip detection sensor, and the output distance information is transmitted to the notification unit. The notification unit determines, based on the distance information received from the chip detection sensor, whether or not the distance between the sensor and the chips is equal to or smaller than a predetermined distance, and issues a notification to the outside when it is determined to be equal to or smaller than the predetermined distance. This allows a worker to take measures, such as leveling the chips accumulated in the chip bucket, upon receiving the notification. As a result, entry of chips into the tubular body through the lower end opening of the tubular body and spilling of chips out of the chip bucket due to excessive accumulation of chips can be suppressed.

Further, since the chip detection sensor is fixed to the tubular body, the height position of the chip detection sensor also can be set to an appropriate height corresponding to the upper end position of the chip bucket by adjusting the height position of the lower end opening of the tubular body in accordance with the upper end position of the chip bucket. This allows the status of accumulation of chips in the chip bucket to be properly detected by the chip detection sensor.

Examples of the configuration of the notification by the notification unit include a configuration in which an alarm is displayed on a display device as appropriate and a configuration in which an alarm sound is output from a speaker. Further, since the chip detection sensor can accurately detect the distance without contact, the chip detection sensor may be, for example, but not limited to, an ultrasonic sensor (seventh aspect).

Further, the above-described first aspect may be configured such that the tubular body is provided to be extendable and contractible in the up-down direction. In this aspect (eighth aspect), the height position of the lower end opening can be adjusted by extending and contracting the tubular body. Note that examples of specific structures for extending and contracting the tubular body include a bellows structure.

### ADVANTAGEOUS EFFECT OF THE INVENTION

As described above, according to the chip conveyor of the present invention, the tubular body open at the top and bottom thereof is engaged with the discharge portion of the housing such that its internal space communicates with the discharge outlet of the housing. Further, the tubular body is provided such that the height position of its lower end opening is displaceable. Therefore, the height position of the lower end opening can be adjusted to a position corresponding to the upper end height of the chip bucket. By properly setting the height position of the lower end opening of the tubular body, from which the chips are discharged to the outside, relative to the height of the upper end of the chip bucket, the discharged chips can be reliably guided and collected into the chip bucket without being affected by the height of the upper end of the chip bucket. As a result, scattering of the chips around the chip bucket can be prevented.

### BRIEF DESCRIPTION OF THE DRAWINGS

FIG. 1 is a longitudinal sectional view showing a chip conveyor according to an embodiment.

FIG. 2 is a perspective view showing the chip conveyor according to the embodiment.

FIG. 3 is a front view showing the chip conveyor according to the embodiment.

FIG. 4 is a cross-sectional view taken along line IV-IV in FIG. 3.

FIG. 5 is a view corresponding to FIG. 4, showing a state where a movable housing unit is displaced downward.

FIG. 6 is a block diagram illustrating a schematic configuration of a chip alarm device provided in the chip conveyor according to the embodiment.

FIG. 7 is a schematic diagram illustrating how chips accumulate in a chip bucket installed below a discharge outlet of a conventional chip conveyor that does not have the movable housing unit and that is provided with a chip detection sensor.

FIG. 8 is a schematic diagram illustrating how chips accumulate in a chip bucket installed below a discharge outlet of the chip conveyor according to the embodiment.

### DETAILED DESCRIPTION

Specific embodiments of the present invention will be described below with reference to the drawings.

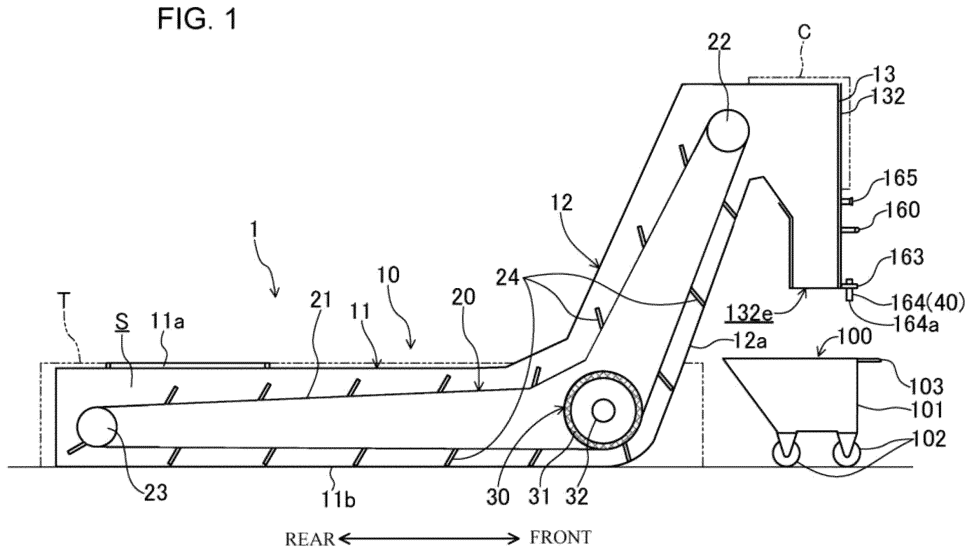

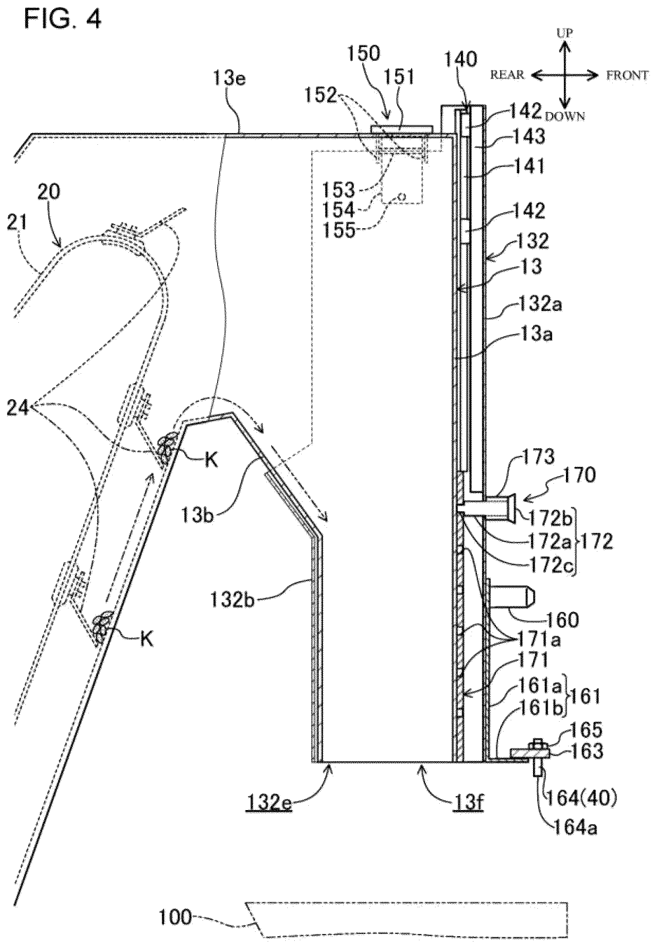

FIG. 1 is a side view showing a chip conveyor 1 according to an embodiment. The chip conveyor 1 separates chips K (see FIG. 4) contained in coolant discharged from a machine tool (not shown) and discharges them into a chip bucket 100. In the following description, unless otherwise specified, the terms front, rear, left, and right are defined with respect to the chip conveyor 1. They are indicated by the directional axes in the figures.

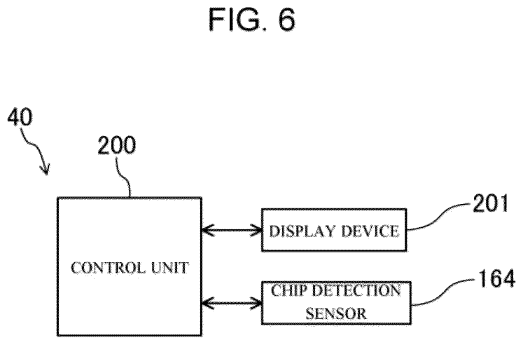

The chip conveyor 1 includes a housing 10, a tubular body 132 attached to the housing 10, a chip conveying mechanism 20, a drum-shaped filtering unit 30, and a notification device 40 (see FIG. 6 described later).

The housing 10 includes a flat box-shaped horizontal unit 11 extending in the front-rear direction, an inclined unit 12 extending obliquely upward from the front end of the horizontal unit 11, and a discharge unit 13 connected to the upper end of the inclined unit 12 and serving as the discharge portion.

The horizontal unit 11 is housed in a coolant tank T attached to the machine tool. An inlet 11a for receiving coolant containing chips K discharged from the machine tool is formed at the rear end of an upper surface of the horizontal unit 11.

The space in the horizontal unit 11 and the space in the inclined unit 12 are continuously connected to form a tunnel-like space S. The chip conveying mechanism 20, which will be described later, is housed in the tunnel-like space S.

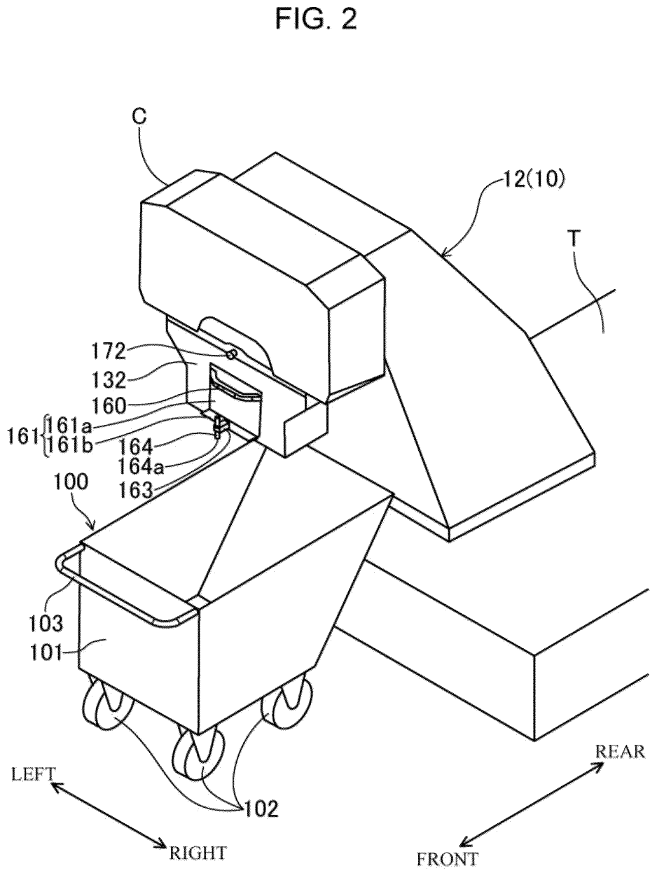

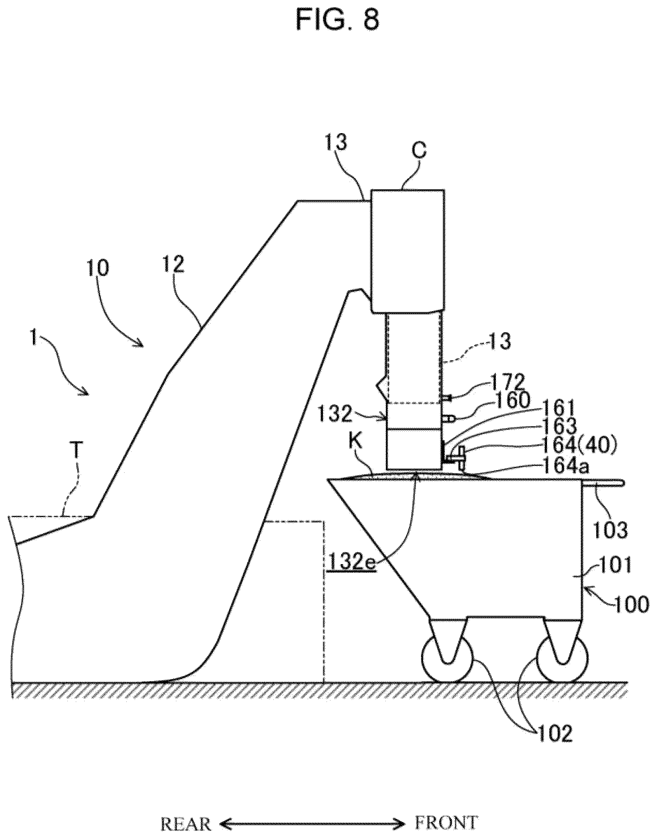

The discharge unit 13 is located at the front side of the upper end of the inclined unit 12. The discharge unit 13 is covered by a decorative cover C. Note that, for clarity of illustration, the decorative cover C is shown only in FIG. 1, FIG. 2, and FIG. 8 (which will be described later) and is omitted in the other figures.

The discharge unit 13 is formed in a flat box-like shape having a small thickness in the front-rear direction, as viewed from the front side. The space in the discharge unit 13 is continuously connected at the upper end thereof to the space in the inclined unit 12. Further, the discharge unit 13 has an opening at the lower end thereof and the space in the discharge unit 13 functions as a discharge path for discharging chips K conveyed by the chip conveying mechanism 20, to the outside of the housing 10 through the opening 13f.

The tubular body 132, which is similarly formed in a box-like shape and is open at both the top and bottom thereof, is externally fitted on the discharge unit 13. This tubular body 132 is disposed on the outside of the discharge unit 13 so as to surround side walls 131a to 131d of the discharge unit 13 from the outside. The tubular body 132 is provided to be slidable in the up-down direction with respect to the discharge unit 13. The lower end opening of the tubular body 132 functions as a discharge outlet 132e for discharging chips K downward. A worker can adjust the up-down position (height) of the discharge outlet 132e by adjusting the up-down position of the tubular body 132.

A chip bucket 100 for collecting chips K is disposed below the discharge outlet 132e. As shown in FIG. 2, the chip bucket 100 includes a bucket body 101 having a bottomed box-like shape and open at the top thereof, four wheels 102 attached to a lower surface of the bucket body 101, and a handle unit 103 attached to the worker-side side surface of the bucket body 101. The chip bucket 100 is configured such that a worker can manually push it in any direction by holding the handle unit 103.

The chip conveying mechanism 20 is housed in the space S formed by the horizontal unit 11 and the inclined unit 12. The chip conveying mechanism 20 includes a pair of endless chains 21 arranged with a spacing in the left-right direction, a drive sprocket 22 and a driven sprocket 23 around which the pair of endless chains 21 are looped, and a plurality of scrapers 24 arranged along the rotational direction of the endless chains 21. The drive sprocket 22 is housed in an upper end portion of the inclined unit 12. Each of the plurality of scrapers 24 is composed of a plate-like member extending in the left-right direction. The left and right ends of each scraper 24 are respectively connected to the left and right endless chains 21.

The drum-shaped filtering unit 30 is housed in a portion close to the connection between the horizontal unit 11 and the inclined unit 12. The drum-shaped filtering unit 30 is composed of a hollow cylindrical member having a filter 31 on the outer periphery thereof. The drum-shaped filtering unit 30 is disposed such that the axis thereof is oriented in the left-right direction (i.e., the direction perpendicular to the paper surface of FIG. 1). The space in the drum-shaped filtering unit 30 communicates with the coolant tank T through a communication hole 32 that penetrates the axial center of the drum-shaped filtering unit 30. The pair of endless chains 21 of the chip conveying mechanism 20 described above are looped around the drum-shaped filtering unit 30. This allows the drum-shaped filtering unit 30 to rotate together with the pair of endless chains 21.

Next, the operation of separating and conveying chips K, which is performed in the chip conveyor 1 when the machine tool (not shown) is in operation, will be described.

In this separating and conveying operation, the drive sprocket 22 of the chip conveyor 1 is first rotationally driven by a motor (not shown). This causes the pair of endless chains 21 to start looping along the side plates of the horizontal unit 11 and inclined unit 12. Accordingly, the plurality of scrapers 24 start looping along with the pair of endless chains 21. In this state, when coolant containing chips K discharged from the machine tool flows into the housing 10 through the inlet 11a, the chips K contained in the coolant are captured by the scrapers 24 that are looping. Along with the movement of the scrapers 24, the chips K (see FIG. 4) captured by the scrapers 24 move along the bottom plate 11b of the horizontal unit 11 and then along the bottom plate 12a of the inclined unit 12 connected to the right end of the bottom plate 11b, and fall into the discharge unit 13 after reaching the upper end of the bottom plate 12a.

The chips K that have fallen into the discharge unit 13 flow inside the discharge unit 13 and are eventually discharged downward from the discharge outlet 132e of the tubular body 132. The chips K discharged from the discharge outlet 132e fall into the chip bucket 100 disposed below the discharge outlet 132e; thus, the chips K are collected. On the other hand, the coolant flows into the inner space of the drum-shaped filtering unit 30 through the filter 31 provided on the outer periphery of the drum-shaped filtering unit 30 (see FIG. 1). Thus, the coolant is filtered by the filter 31. The filtered coolant is collected into the coolant tank T through the communication hole 32.

### Details of Discharge Unit

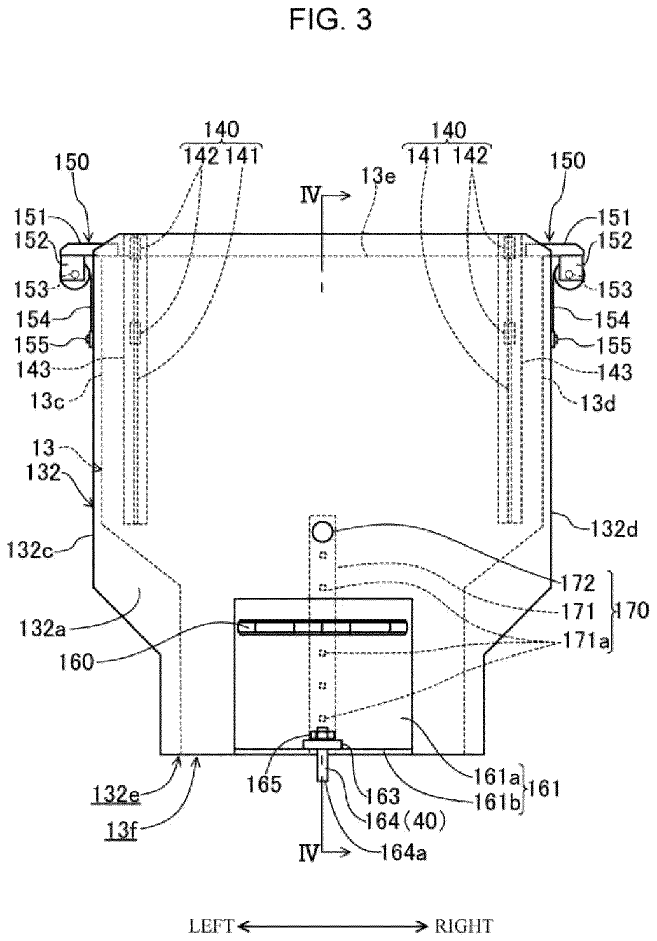

As shown in FIG. 3 to FIG. 5, the discharge unit 13 has a front side plate 13a, a rear side plate 13b, a left side plate 13c, a right side plate 13d, and a top plate 13e. The discharge unit 13 has a rectangular horizontal cross-section that is elongated in the left-right direction.

The discharge unit 13 is formed such that the spacing between the left and right side plates 13c and 13d at the lower end thereof is narrower than that at the upper portion. This allows the width of the lower end opening 13f of the discharge unit 13 in the left-right direction to be narrowed (reduced). Therefore, not only the chip bucket 100 but also, for example, a drum or the like having a relatively small upper opening area can be used as the chip collection container.

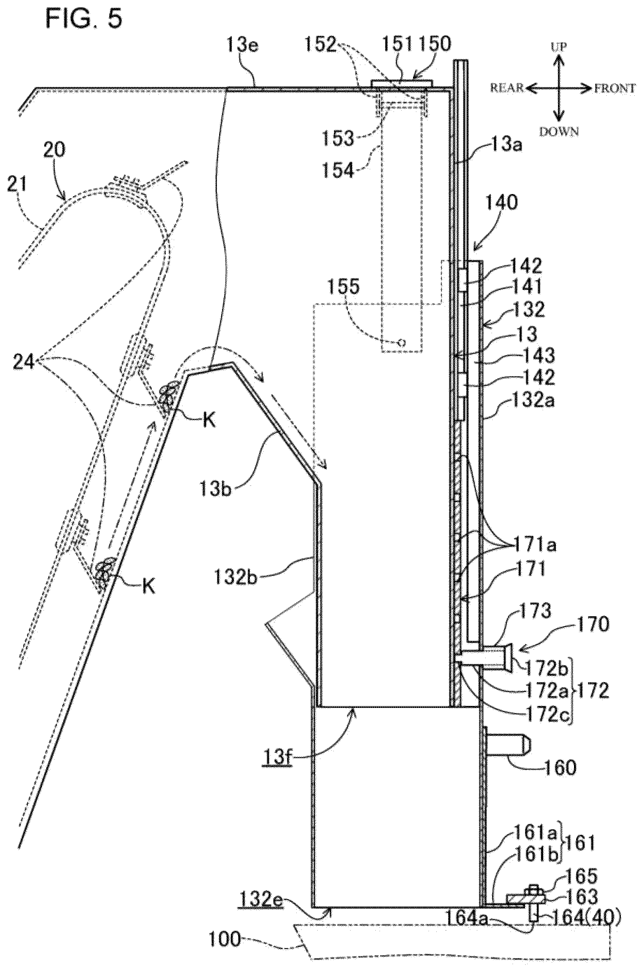

Further, the rear side plate 13b of the discharge unit 13 forms a slope inclined downward toward the front side. As a result, as shown by the two-dot chain line arrows in FIG. 4 and FIG. 5, the chips K conveyed to the vicinity of the upper end of the rear side plate 13b by the chip conveying mechanism 20 can be dropped downward in an aggregated state while being guided forward inside the discharge unit 13.

The front side plate 13a of the discharge portion 13 is arranged vertically. A pair of left and right guide rails 141 and a positioning plate 171, which will be described later, are attached to the front face of the front side plate 13a.

### Details of Tubular Body

As shown in FIG. 3 to FIG. 5, the tubular body 132 has a front side plate 132a, a rear side plate 132b, a left side plate 132c, and a right side plate 132d. The front, rear, left, and right side plates 132a to 132d have a shape corresponding to the front, rear, left, and right side walls 13a to 13d of the discharge unit 13, respectively.

That is, the tubular body 132 is formed such that the spacing between the left and right side plates 132c and 132d at the lower end thereof is narrower than that at the upper portion. Further, the rear side plate 132b forms a slope inclined downward toward the front side. Inclining the rear side plate 132b downward in this manner allows the tubular body 132 to be moved further downward, that is, to be moved to a position at which the upper end of the tubular body 132 slightly overlaps the lower end of the discharge unit 13. This also allows the opening (upper end opening) of the tubular body 132 that receives chips K to be made wide (see FIG. 5), so that the chips K can be reliably received in the tubular body 132 and the chips K can be prevented from spilling out from the rear side of the upper end of the tubular body 132.

On the front face of the front side plate 132a of the tubular body 132, a handle unit 160 and a bracket 161 having an L-shaped cross-section are attached. The bracket 161 holds a chip detection sensor 164 which will be described later.

The handle unit 160 is formed in a U-shape as viewed from above. The handle unit 160 is attached to a middle portion in the left-right direction of the front side plate 132a of the tubular body 132. The handle unit 160 is fastened together with the bracket 161 to the front side plate 132a of the tubular body 132. The handle unit 160 is used when a worker slides the tubular body 132 up and down.

The bracket 161 has a vertical plate portion 161a and a horizontal plate portion 161b that protrudes forward from the lower end of the vertical plate portion 161a. A sensor holder 163 is attached to a middle portion in the left-right direction of the horizontal plate portion 161b. The sensor holder 163 has a through hole through which a screw portion formed at the upper end of the chip detection sensor 164 penetrates. The chip detection sensor 164 is fixed to the sensor holder 163 by a nut 165 screwed to the upper end of the chip detection sensor 164. A worker can adjust the up-down position of the chip detection sensor 164 by loosening the nut 165.

### Biasing Mechanism

The tubular body 132 is suspended in a state of being biased upward by left and right biasing mechanisms 150 fixed to the top plate 13e of the discharge unit 13.

Specifically, each biasing mechanism 150 has a horizontal protruding plate 151, a pair of vertical support plates 152, a drum 153, and a constant load spring 154. The horizontal protruding plate 151 is fixed to the respective end in the left-right direction of the upper face of the top plate 13e. The horizontal protruding plate 151 protrudes outward from the respective end in the left-right direction of the top plate 13e. The pair of vertical support plates 152 protrude downward from the lower face of the protruding portion of the horizontal protruding plate 151. The pair of vertical support plates 152 are spaced apart from each other in the forward-backward direction with the drum 153 interposed therebetween. The drum 153 is supported at both ends thereof by the pair of vertical support plates 152. The constant load spring 154 is a long plate spring bent with a constant curvature and is wound around the drum 153 so as to be pulled out downward. The constant load spring 154 is fixed to the respective one of the left and right side plates 132c and 132d of the tubular body 132 by a bolt 155 at the lower end thereof (at the pulled-out end thereof). Thus, the tubular body 132 is biased upward by the constant load spring 154 with a constant biasing force against the gravitational force, regardless of the moving stroke amount (the up-down position).

### Guide Mechanism and Positioning Mechanism

The chip conveyor 1 further has a guide mechanism 140 that slidably supports the tubular body 132 in the up-down direction relative to the discharge unit 13 of the housing 10, and a positioning mechanism 170 for positioning the tubular body 132 in the up-down direction.

As shown in FIG. 3 and FIG. 4, the guide mechanism 140 includes left and right guide rails 141 fixed to the discharge unit 13, and sliders 142 fixed to the tubular body 132 and slidably engaged with the respective guide rails 141. Note that the arrangement of the guide rails 141 and the sliders 142 is relative, and the guide rails 141 may be provided on the tubular body 132, while the sliders 142 may be provided on the discharge unit 13.

The left and right guide rails 141 are spaced apart from each other in the left-right direction and fixed to the front surface of the front side plate 13a of the discharge portion 13. The left and right guide rails 141 are provided to extend in the up-down direction.

The sliders 142 are fixed to the backside (rear surface) of the front side plate 132a of the tubular body 132 via rib plates 143. The rib plates 143 are provided at positions corresponding to the left and right guide rails 141. Two sliders 142 spaced apart from each other in the up-down direction are fixed to each rib plate 143. The two sliders 142 fixed to the left rib plate 143 engage with the left guide rail 141, and the two sliders 142 fixed to the right rib plate 143 engage with the right guide rail 141.

The positioning mechanism 170 includes a positioning plate 171 attached to the discharge unit 13 and a positioning pin 172 attached to the tubular body 132.

The positioning plate 171 is fixed to the front surface of the front side plate 13a of the discharge unit 13. The positioning plate 171 is arranged along the up-down direction at a middle position in the left-right direction on the front surface of the front side plate 13a. The positioning plate 171 is formed with a plurality of positioning holes 171a (five positioning holes 171a in this example) that are spaced apart from each other in the up-down direction. The pitch and number of the positioning holes 171a are appropriately set depending on the height position of the tubular body 132 to be adjusted.

The positioning pin 172 is attached to a middle portion in the left-right direction of the front side plate 132a of the tubular body 132. Further, the positioning pin 172 is disposed above the handle unit 160. The positioning pin 172 penetrates the front side plate 132a of the tubular body 132 in the front-rear direction. The positioning pin 172 is guided so as to be moved forward and backward in the front-rear direction by a guide tube 173 fixed to the front side plate 132a of the tubular body 132.

Specifically, the positioning pin 172 has a cylindrical axial pin body portion 172a guided by the guide tube 173, a head portion 172b connected to the proximal end of the pin body portion 172a, and a distal engagement portion 172c coaxially connected to the distal end of the pin body portion 172a. The distal engagement portion 172c is configured to be engageable with each positioning hole 171a of the positioning plate 171. By the engagement of the distal engagement portion 172c with the positioning hole 171a formed in the positioning plate 171, the tubular body 132 is positioned in the up-down direction with respect to the discharge unit 31 via the positioning pin 172.

Here, the positioning pin 172 is constantly biased to the rear side (the left side of FIG. 4) by a biasing member (not shown). The head portion 172b functions as a detent by abutting against the end surface of the guide tube 173 in opposition to the biasing force of the biasing member. The head portion 172b also functions as a grip for a worker to pull the positioning pin 172 forward in opposition to the biasing force of the biasing member.

### Notification Device

The notification device 40 issues an external notification as an alarm when the level of accumulation of chips K in the chip bucket 100 reaches or exceeds a predetermined level. Specifically, as shown in FIG. 6, the notification device 40 has the chip detection sensor 164, a display device 201, and a control unit 200 serving as the notification unit that executes the notification.

For example, the chip detection sensor 164 is composed of an ultrasonic sensor. The chip detection sensor 164 is cylindrical in appearance and has a transmission/reception surface 164a on a distal end surface thereof. The chip detection sensor 164 outputs an ultrasonic wave from the transmission/reception surface 164a and receives a reflected wave from chips K as the target object at the transmission/reception surface 164a. Upon receiving an ultrasonic wave at the transmission/reception surface 164a, the chip detection sensor 164 transmits, to the control unit 200, a signal indicating the reception of the ultrasonic wave. The signal is used by the control unit 200 to calculate a distance from the chip detection sensor 164 to chips K as the target object. The signal corresponds to distance information.

The display device 201 is composed of, for example, a monitor provided on an operation panel of the machine tool. The display device 201 displays needed information upon receiving a command from the control unit 200.

The control unit 200 is composed of a computer having a CPU, ROM, and RAM. The control unit 200 is connected to the chip detection sensor 164 and the display device 201 so as to transmit and receive signals. Based on the signal from the chip detection sensor 164, the control unit 200 measures the time from the transmission to reception of the ultrasonic wave. Further, the control unit 200 calculates the distance between the transmission/reception surface 164a of the chip detection sensor 164 and the chips K as the target object based on the measured time.

Then, the control unit 200 executes a determination process to determine whether or not the calculated distance is equal to or smaller than a predetermined distance. If the calculated distance is determined to be equal to or smaller than the predetermined distance, the control unit 200 causes the display device 201 to display an alarm. This predetermined distance is set as the distance between the transmission/reception surface 164a of the chip detection sensor 164 and chips K located on an extension of the transmission/reception surface 164a in a state where chips K accumulated directly below the discharge outlet 132 e are located slightly (e.g., 10 cm to 15 cm) below the discharge outlet 132e. Preferably, the predetermined distance can be set to any value by a worker via an operation panel.

For example, a message like “The chips K in the chip bucket have exceeded the limit level. Please discard the chips.” may be displayed as the alarm on the display device 201. The alarm displayed is not limited to such contents. Any alarm may be displayed as long as it can alert the worker that the chips K accumulated in the chip bucket 100 have exceeded the limit level (a level at which there is a risk that the chips K could enter the discharge outlet 132e). The alarm displayed is not limited to a message as in this example, and may be, for example, a symbol, a mark, or the like.

Note that, needless to say, if it is determined in the control unit 200 that the distance between the chip detection sensor 164 and the chips K located on the extension of the chip detection sensor 164 exceeds the predetermined distance, the alarm display by the display device 201 is not performed.

### Discharge Outlet Height Adjustment Operation

An adjustment operation for adjusting the height position of the discharge outlet 132e in the chip conveyor 1 configured as described above will be described. For example, as shown in FIG. 4, if the distance between the discharge outlet 132e and the upper end position of the chip bucket 100 is large, there is a risk that chips K discharged from the discharge outlet 132e could scatter without being collected into the chip bucket 100. In such a case, the worker can adjust the position of the discharge outlet 132e in accordance with the following procedure so as to reduce the distance between the discharge outlet 132e and the upper end position of the chip bucket 100 (see FIG. 5).

That is, in the state shown in FIG. 4, the worker grips the handle unit 160 with one hand to hold the tubular body 132 and pulls out the positioning pin 172 toward the front side (the right side of FIG. 4) with the other hand. Thereby, the engagement of the distal engagement portion 172c of the positioning pin 172 with the positioning hole 171a located at the uppermost position of the positioning plate 171 is released so that the tubular body 132 can be moved in the up-down direction.

In this state, the worker slides the tubular body 132 downward while gripping the handle unit 160. At this time, since the tubular body 132 is constantly biased upward against the gravitational force by the biasing mechanism 150, the load applied to the worker is reduced compared to the actual weight of the tubular body 132. Therefore, the worker can easily move the tubular body 132 up and down with a slight force (light load).

As shown in FIG. 5, the worker stops the movement of the tubular body 132 when the discharge outlet 132e reaches a position near the upper end position of the chip bucket 100. In the example shown in FIG. 5, the worker engages the distal engagement portion 172c of the positioning pin 172 with the positioning hole 171a located at the lowermost position of the positioning plate 171. It should be noted that the positioning hole 171a with which the positioning pin 172 is to be engaged is determined according to the height position of the tubular body 132.

By this operation, the height position of the discharge outlet 132e is adjusted to a position corresponding to the upper end height of the chip bucket 100. This ensures that chips K discharged from the discharge outlet 132e are reliably guided and collected into the chip bucket 100, so that scattering of the chips K around the chip bucket 100 is prevented.

### Effects of the Present Embodiment

As described above, the chip conveyor 1 of the present embodiment is configured such that the discharge outlet for discharging chips K is defined by the discharge outlet 132e of the tubular body 132 that is provided to be displaceable (adjustable) in height so that the height position of the discharge outlet 132e can be adjusted by adjusting the position of the tubular body 132 in the up-down direction.

Adjusting the height position of the discharge outlet 132e, from which chips K are discharged, to a position corresponding to the upper end height of the chip bucket 100 allows chips K discharged from the discharge outlet 132e of the chip conveyor 1 to be reliably collected into the chip bucket 100 without being affected by the upper end height of the chip bucket 100.

In the present embodiment, the movement of the tubular body 132 in the up-down direction relative to the discharge unit 13 is guided by the guide mechanism 140. Therefore, the tubular body 132 can be moved easily and smoothly moved in the up-down direction.

Further, in the present embodiment, the tubular body 132 is adjusted in height position by being moved in the up-down direction through the guide mechanism 140 and then the height position of the tubular body 132 is determined (fixed) by the positioning mechanism 170. Therefore, the height position of the discharge outlet 132e of the tubular body 132 can be easily adjusted, and the height position of the tubular body 132 can be adjusted in a stable and reproducible manner.

Further, in the present embodiment, the tubular body 132 is constantly biased upward against the gravitational force by the biasing mechanism 150. Therefore, the worker can easily move the tubular body 132 up and down with a slight force.

Further, in the present embodiment, the notification device 40 is provided so that an alarm message is displayed on the display device 201 when the distance between chips K accumulated in the chip bucket 100 and the chip detection sensor 164 is determined to be equal to or smaller than a predetermined distance. Therefore, in response to the alarm message, the worker can take measures such as leveling the chips K accumulated in the chip bucket 100 or replacing the chip bucket 100 with a new empty chip bucket 100. By taking such measures, entry of chips K into the tubular body 132 through the discharge outlet 132e and spilling of chips K out of the chip bucket 100 due to further accumulation of chips K in the chip bucket 100 can be prevented.

Here, it is conceivable to provide the chip detection sensor 164 on the chip bucket 100. However, in this case, there is a problem that a sensor cable will obstruct movement of the chip bucket 100. Further, there is a problem that the chip detection sensor 164 must be provided on each and every chip bucket 100, which results in an increase in cost. In contrast, in the present embodiment, the chip detection sensor 164 is provided on the chip conveyor 1, whereby such problems can be avoided.

Furthermore, the chip detection sensor 164 is fixed to the tubular body 132 of the chip conveyor 1. Therefore, when the height position of the tubular body 132 is adjusted, the height position of the chip detection sensor 164 is also adjusted to a position corresponding to the height of the chip bucket 100 along with the adjustment of the height position of the tubular body 132. As a result, the cumbersome work of adjusting the height position of the chip detection sensor 164 each time can be omitted.

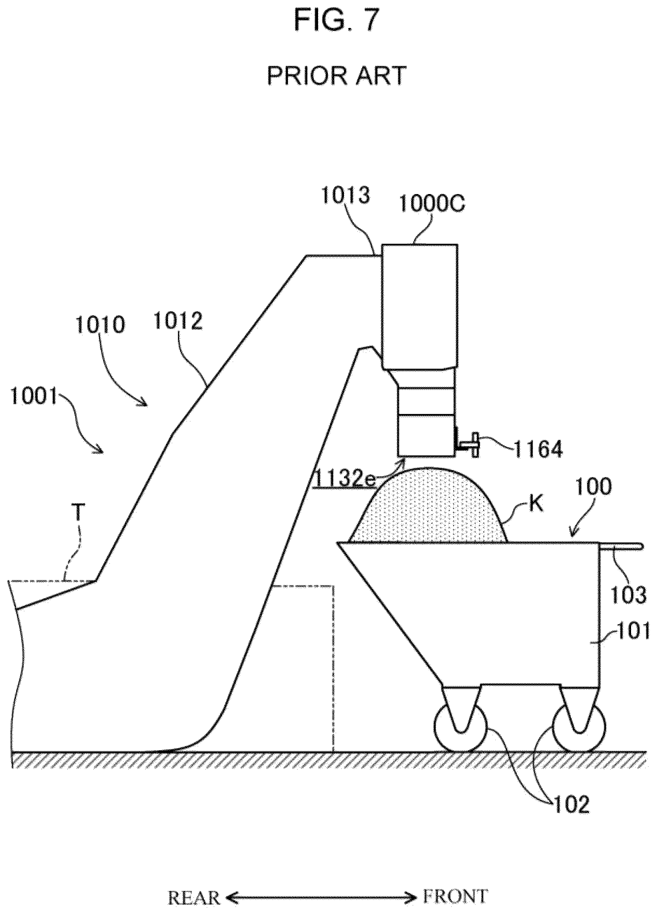

This feature is described based on a comparison with a traditional chip conveyor 1001 shown in FIG. 7. In FIG. 7, the components identical to those in the present embodiment are denoted by adding 1000 to the reference numerals used in the present embodiment.

In the conventional chip conveyor 1001 shown in FIG. 7, the upper end housing unit 1013 does not have the tubular body 132 as in the present embodiment. Therefore, there is no means for adjusting the distance between the chip detection sensor 1164 mounted on the discharge portion 1013 and the chip bucket 100. For example, when a chip bucket 100 having a low upper end height is used as shown in FIG. 7, the distance between the chip detection sensor 1164 and the chip bucket 100 remains large. As a result, a problem occurs that chips K are heaped in the chip bucket 100 and overflow to the outside before being detected by the chip detection sensor 1164 (more precisely, before the distance between the chip detection sensor 1164 and the chips K reaches or falls below a predetermined distance).

In contrast, according to the chip conveyor 1 of the present embodiment, since the chip detection sensor 164 is fixed to the tubular body 132, the height position of the chip detection sensor 164 is adjusted to a position close to the upper end position of the chip bucket 100 along with adjustment of the height position of the tubular body 132 as shown in FIG. 8. Therefore, chips K are detected by the chip detection sensor 164 before being heaped over the upper end position of the chip bucket 100.

### Other Embodiments

In the above-described embodiment, in order to adjust (displace) the height position of the discharge outlet 132e, the configuration is employed in which the tubular body 132 is externally fitted to the discharge unit 13 and is moved in the up-down direction. However, the present invention is not limited to this configuration. For example, a configuration may be employed in which the tubular body 132 is composed of a bellows-structured member and connected at the upper end thereof to the lower end of the discharge unit 13. In this case, by extending and retracting the lower end of the bellows-structured tubular body 132 in the up-down direction, the height position of the discharge outlet 132e as the lower end opening of the tubular body 132 is adjusted.

In the above-described embodiment, the tubular body 132 is externally fitted to the discharge unit 13. However, conversely, the tubular body 132 may be internally fitted to the discharge unit 13, in other words, the discharge unit 13 may be externally fitted to the tubular body 132. In this case, the biasing mechanism 150, the guide mechanism 140, and the positioning mechanism 170 can be provided according to the fitting relationship between the tubular body 132 and the discharge unit 13.

Further, in the above-described embodiment, the biasing force in the biasing mechanism 150 is generated by the constant load spring 154. However, the present invention is not limited thereto. The biasing force may be generated by a balancer composed of a cylinder using a fluid or may be applied to the tubular body 132 by using a conical body as a counterweight.

Further, in the above-described embodiment, the tubular body 132 is configured to be moved up and down manually by a worker. However, the present invention is not limited thereto. For example, the tubular body 132 may be raised and lowered by a drive actuator such as a motor or a cylinder. In this case, for example, a configuration may be employed in which the tubular body 132 is raised by the drive actuator when an up button is pressed by the worker, and the movable housing unit 132 is lowered by the drive actuator when a down button is pressed by the worker.

Further, in the above-described embodiment, the chip detection sensor 164 is arranged such that its chip detection direction (that is, the axis of the chip detection sensor 164) is directed vertically downward. However, the present invention is not limited thereto. For example, the chip detection sensor 164 may be arranged with an inclination such that its chip detection direction is directed toward a position below the discharge outlet 132e.

Furthermore, in the above-described embodiment, the chip detection sensor 164 is composed of an ultrasonic sensor. However, the present invention is not limited thereto. For example, the chip detection sensor 164 may be composed of a light sensor or the like.

Further, in the above-described embodiment, the sensor holder 163 is configured to allow adjustment only in the up-down position of the chip detection sensor 164. However, the present invention is not limited thereto. For example, the sensor holder 163 may be configured to allow adjustment in the three-dimensional tilt of the chip detection sensor 164. For example, the sensor holder 163 may include a rotary hinge mechanism that rotates about an axis extending in the front-rear direction and a rotary hinge mechanism that rotates about an axis extending in the left-right direction.

In the above-described embodiment, the control unit 200 may be a dedicated control unit for the chip detection sensor 164 and the display device 201, or, for example, may be shared as an overall control unit for controlling the entire operation of the machine tool.

In the above-described embodiment, the display device 201 is configured by the monitor provided on the operation panel of the machine tool. However, the display device 201 is not limited thereto and may be composed of a dedicated monitor that is provided on the chip conveyor 1. For example, the dedicated monitor may be provided on the front surface of the fixed housing unit 131.

In the above embodiments, the chip conveyor 1 is not limited to the scraper type as described above, and may be, for example, a hinge type or a magnet type.

Note that the foregoing description of embodiments is illustrative and not restrictive in all respects. Modifications and variations can be made as appropriate by a person skilled in the art. The scope of the present invention is indicated by the claims, not by the embodiments described above. Further, the scope of the present invention encompasses modifications of the embodiments that fall within the scope equivalent to the claims.

### LISTING OF REFERENCE CHARACTERS

1: Chip Conveyor
10: Housing
11a: Inlet
13: Discharge Unit
40: Notification Device
100: Chip Bucket
132: Tubular Body
132e: Discharge Outlet
140: Guide Mechanism
141: Guide Rail
142: Slider
143: Rib Plate
150: Biasing Mechanism
164: Chip Detection Sensor
170: Positioning Mechanism
171: Positioning Plate
171a: Positioning Hole
172: Positioning Pin
200: Control Unit (Notification Unit)
201: Display Device

1. A chip conveyor comprising: a housing that has an inlet receiving chips and a discharge outlet for discharging the chips downward; and a conveying mechanism that is housed in the housing and configured to convey the chips received through the inlet toward the discharge outlet, the chip conveyor being configured to discharge the chips through the discharge outlet to a chip bucket disposed below the discharge outlet, wherein:
a tubular body open at top and bottom thereof is engaged with a discharge portion of the housing where the discharge outlet is formed, so that an internal space of the tubular body communicates with the discharge outlet;
the tubular body is provided such that a height position of its lower end opening is displaceable;
the discharge portion of the housing is formed in a tubular shape having a rectangular horizontal cross-section and is provided to hang downward:
the tubular body has a rectangular horizontal cross-section corresponding to the discharge portion, covers an outer peripheral surface of the discharge portion, and is provided to be movable in an up-down direction with respect to the discharge portion; and
a front-side outer peripheral surface of the discharge portion that is provided at a front side in a front-rear direction of the chip conveyor in the outer peripheral surface of the discharge portion and a front-side inner peripheral surface of the tubular body that is provided corresponding to the front-side outer peripheral surface of the discharge portion at the front side in the front-rear direction in an inner peripheral surface of the tubular body are spaced apart from each other to form a space between them, and at least a part of a positioning mechanism configured to position a height position of the tubular body relative to the discharge portion is provided within the space.

2. (canceled)

3. The chip conveyor of claim 21, comprising a guide mechanism that engages with the discharge portion of the housing and the tubular body and is configured to guide relative up-and-down movement between the discharge portion and the tubular body, wherein the guide mechanism is provided in the space formed by the front-side outer peripheral surface of the discharge portion and the front-side inner peripheral surface of the tubular body.

4. The chip conveyor of claim 21, comprising a biasing mechanism that is configured to apply a biasing force against the gravitational force to the tubular body.

5. (canceled)

6. The chip conveyor of claim 1, comprising:
a chip detection sensor that is fixed to the tubular body and configured to detect chips accumulated in the chip bucket and output distance information regarding a distance from the chip detection sensor to the chips; and
a notification unit that is configured to determine, based on the distance information output from the chip detection sensor, whether or not the distance from the chip detection sensor to the chips is equal to or smaller than a predetermined distance, and to issue an external notification when the distance is determined to be equal to or smaller than the predetermined distance.

7. The chip conveyor of claim 6, wherein the chip detection sensor is an ultrasonic sensor.

8. The chip conveyor of claim 1, wherein the tubular body is provided to be expandable and contractible in the up-down direction.

9. The chip conveyor of claim 3, wherein the guide mechanism is provided to extend in the up-down direction above the discharge outlet of the discharge portion.

10. The chip conveyor of claim 3, wherein:
a rear-side outer peripheral surface of the discharge portion that is provided at a rear side in the front-rear direction in the outer peripheral surface of the discharge portion and a rear-side inner peripheral surface of the tubular body that is provided corresponding to the rear-side outer peripheral surface of the discharge portion at the rear side in the front-rear direction in the inner peripheral surface of the tubular body are in contact with each other to form a sliding surface slidable in the up-down direction; and
the space is provided at a side opposite to the sliding surface with respect to the discharge portion.

11. The chip conveyor of claim 1, wherein:
the discharge portion has an inclined portion inclined obliquely downward from its end portion located on the conveying mechanism side; and
an upper end portion of the tubular body located on the conveying mechanism side is formed to match an outer surface of the inclined portion.

12. The chip conveyor of claim 3, comprising:
a chip detection sensor that is fixed to the tubular body and configured to detect chips accumulated in the chip bucket and output distance information regarding a distance from the chip detection sensor to the chips; and
a notification unit that is configured to determine, based on the distance information output from the chip detection sensor, whether or not the distance from the chip detection sensor to the chips is equal to or smaller than a predetermined distance, and to issue an external notification when the distance is determined to be equal to or smaller than the predetermined distance.

13. The chip conveyor of claim 4, comprising:
a chip detection sensor that is fixed to the tubular body and configured to detect chips accumulated in the chip bucket and output distance information regarding a distance from the chip detection sensor to the chips; and
a notification unit that is configured to determine, based on the distance information output from the chip detection sensor, whether or not the distance from the chip detection sensor to the chips is equal to or smaller than a predetermined distance, and to issue an external notification when the distance is determined to be equal to or smaller than the predetermined distance.

14. The chip conveyor of claim 9, comprising:
a chip detection sensor that is fixed to the tubular body and configured to detect chips accumulated in the chip bucket and output distance information regarding a distance from the chip detection sensor to the chips; and
a notification unit that is configured to determine, based on the distance information output from the chip detection sensor, whether or not the distance from the chip detection sensor to the chips is equal to or smaller than a predetermined distance, and to issue an external notification when the distance is determined to be equal to or smaller than the predetermined distance.

15. The chip conveyor of claim 10, comprising:
a chip detection sensor that is fixed to the tubular body and configured to detect chips accumulated in the chip bucket and output distance information regarding a distance from the chip detection sensor to the chips; and
a notification unit that is configured to determine, based on the distance information output from the chip detection sensor, whether or not the distance from the chip detection sensor to the chips is equal to or smaller than a predetermined distance, and to issue an external notification when the distance is determined to be equal to or smaller than the predetermined distance.

16. The chip conveyor of claim 11, comprising:
a chip detection sensor that is fixed to the tubular body and configured to detect chips accumulated in the chip bucket and output distance information regarding a distance from the chip detection sensor to the chips; and
a notification unit that is configured to determine, based on the distance information output from the chip detection sensor, whether or not the distance from the chip detection sensor to the chips is equal to or smaller than a predetermined distance, and to issue an external notification when the distance is determined to be equal to or smaller than the predetermined distance.

17. The chip conveyor of claim 12, wherein the chip detection sensor is an ultrasonic sensor.

18. The chip conveyor of claim 13, wherein the chip detection sensor is an ultrasonic sensor.

19. The chip conveyor of claim 14, wherein the chip detection sensor is an ultrasonic sensor.

20. The chip conveyor of claim 15, wherein the chip detection sensor is an ultrasonic sensor.

21. The chip conveyor of claim 16, wherein the chip detection sensor is an ultrasonic sensor.
